(19) United States
(12) Patent Application Publication
(10) Pub. No.: US 2012/0132373 A1
(43) Pub. Date: May 31, 2012

(54) Window Covering

(75) Inventor: Tzong -Fu Lin, Taipei (TW)

(73) Assignee: WHOLE SPACE INDUSTRIES LTD, Taipei (TW)

(21) Appl. No.: 12/955,130

(22) Filed: Nov. 29, 2010

(51) Int. Cl. A47H 5/00; E06B 9/48

(52) U.S. Cl. 160/84.04; 160/133

(57) ABSTRACT

A window covering includes a first sheet of material connected to a mounting device adjacent to the front side of the window covering. A second sheet of material may be connected to a roller attached to the mounting device so that the second sheet is windable and unwindable from the roller. A third sheet of material is connected to the mounting device or the first sheet such that the second sheet is positioned between the first and third sheets. The first side of the first sheet is connected to a first side of the third sheet at first positions and the opposite sides of the first and third sheets are connected together at second positions. The second positions may be parallel to the first positions. The second sheet extends from the roller between the first and second positions and between the first sheet and the third sheet.

### FIELD OF INVENTION

The invention relates to window coverings such as Roman shades and mechanisms utilized to lift and lower window coverings.

### BACKGROUND OF THE INVENTION

One popular type of window covering is known as a Roman shade which may also be called a Roman blind, an Austrian shade, a Balloon Shade, or a Soft Shade. This type of shade usually consists of a panel or sheet of material attached along its top edge to a headrail that is gathered at spaced intervals to provide a series of soft transverse folds across the face of the fabric. Consequently, the typical Roman shade has a cascaded or softly pleated appearance. Such Roman shades are usually constructed so that when they are raised from an extended position, they gather from the bottom in generally horizontal folds or pleats until the entire shade resides near the top of the window covering in a retracted position. Often, ballast members such as metal rods or metal bars are positioned within pockets formed across the shade material to provide weight to the shade to form the soft transverse folds. The Roman shades are often operated by pulling on various lift cords which are used in conjunction with guides attached to the shade.

In other versions of Roman shades, such as a Roman shade product sold under the AudraGuard name, the shades are operated by pulling on a beaded looped cord of a loop cord drive. Actuation of the loop cord drive causes a shaft or roller to rotate to wind or unwind a plurality of lifting tapes that pass through metal clips or loops attached to the rear face of the shade material and have a terminal end attached to a bottom portion of the shade material. The winding of the lifting tapes causes the shade material to be raised, or retracted. The unwinding of the lifting tapes causes the shade material to lower, or extend. It should be appreciated that lifting tape may be considered a wider type of lifting cord.

Most prior art Roman shades have window covering material that is formed either of a sheet of a flexible material such as a fabric or film, a plurality of segments of material connected together, or woven wood. The material or interconnected segments are typically provided with a plurality of horizontal folds at points vertically spaced from one another to form folds when the shade is raised. A common method for making a Roman shade is to sew or attach at least two sets of rings or connectors along vertical lines down the back of the fabric material as is shown in U.S. Pat. No. 1,321,800. The spacing of the rings or connectors affects the aesthetic effect of the shade and how the window covering material may look when being raised or lowered. Lift cords pass through the rings and each lift cord is attached to a bottom rail or the lowermost fold. Opposite ends of the lift cords are wound on a spool or shaft in the headrail. The spool or shaft may be turned by a cord loop device or a spring motor to raise and lower the shade. Alternatively, the lift cords may pass through a cord lock and be moved by a user to turn the spool or shaft.

The shade may also include spacer cords that pass through the rings. The spacer cords are typically attached to the headrail of the shade and the rings and are configured to help improve the aesthetic effect of the shade when the window covering material is raised or lowered. A liner may also be included in such shades. Additionally, Roman shades may be configured as a top down bottom up shade. Roman shades may also have other configurations, such as the configurations disclosed in U.S. Pat. Nos. D473,743, D468,950, and 7,624,784, 6,988,526, 6,817,399, 6,662,845, 5,787,951, 5,566,735, 5,425,408 and 4,846,243 and U.S. Patent Application Publication Nos. 2008/0295975, 2008/0277074, 2007/0175593, 2006/0060308 and 2006/0157204.

Roman shades may be fabricated by fabricators to make a Roman shade in a custom size to fit a customer's window opening. Fabricators may mistakenly measure or determine the necessary length of the window covering material of a Roman shade or the desired positioning of the rings on the back of the window covering material. For instance, a fabricator may want to adjust the position of the rings to achieve a different aesthetic effect for the raising and lowering of window covering material after reviewing the look provided by the initial positioning of the rings. Since rings are often sewn or affixed to the window covering material, such repositioning can be difficult and time consuming. Alternatively, Roman shades may include fastening mechanisms that permit fabricators to more easily adjust the position of the window covering material relative to the lift cords to which the window covering is attached.

On occasion, children have been able to get behind a lowered Roman shade and become entangled in one of the lift cords. If the lift cord is around the child's neck and the child falls, the cord could act as a noose and strangle the child. Indeed, reports of such incidents have prompted major retailers to issue a recall of one product line of Roman shades and the United States Consumer Product Safety Commission has issued a warning about the danger of child entanglement and hanging from the cords in Roman shades.

There have also been incidents of child entanglements in lift cords of venetian blinds and other types of window coverings. As a result, the art has developed various types of child safety devices that are intended to prevent deaths of children who become entangled in lift cords. For instance, U.S. Pat. Nos. 7,318,251, 7,261,138, 7,225,850, 7,117,918, 7,086,446, 7,000,672, 6,948,546, 6,918,425, 6,860,312, 6,637,493, 6,484,787, 6,431,248, 5,630,458, 5,533,559 and 4,909,298 and U.S. Patent Application Publication Nos. 2008/0110581, 2007/0023149 and 2006/0144526 disclose child safety devices for blinds. Child safety devices may be configured to keep the lift cords taught so that the cords cannot be pulled away from the window covering material and form a noose or release the cord from the shade when a child becomes entangled in the shade. Most, if not all of the cord release devices are not well suited for use on Roman shades. Moreover, many conventional child safety devices for window coverings are visible from the front of the shade and detract from the aesthetic effect of the shade.

A new window covering is needed to replace or change a conventional Roman shade design that utilizes exposed lift cords or lifting tape. Such a window covering preferably provides the same or a substantially similar aesthetic effect provided by conventional Roman shades while also providing aesthetic advantages to the rear face, or window facing face, of the window covering.

### SUMMARY OF THE INVENTION

A window covering may include a mounting device, a roller attached to the mounting device that is rotatable in a first direction and a second direction that is opposite the first direction, three sheets of material, and a plurality of clips. The first sheet of material may be connected to the mounting device adjacent to the front side of the window covering. The second sheet of material may be connected to the roller so that the second sheet of material is windable about the roller when the roller is rotated in the first direction and is unwindable from the roller when the roller rotates in the second direction. The third sheet of material is connected to at least one of the first sheet of material and the mounting device adjacent to the rear side of the window covering such that the second sheet of material is positioned between the first and third sheets of material. The clips include a first set of clips and a second set of lips. The first set of clips are positioned adjacent to first edges of the first and third sheets of material and the second set of clips are positioned adjacent to second edges of the first and third sheets of material that are opposite to the first edges of the first and third sheets of material. Each clip of the first set of claps is attached to the first sheet of material adjacent to a respective first edge portion of the first sheet and is also attached to the third sheet of material adjacent to a respective first edge portion of the third sheet of material. Each clip of the second set of clips is attached to the first sheet of material adjacent to a respective second edge portion of the first sheet of material and is attached to the third sheet of material adjacent to a respective second edge portion of the second sheet of material. The second sheet of material extends from the roller between the first and second sets of clips and between the first sheet of material and the third sheet of material.

An embodiment of the window covering may be a Roman shade. Of course, other embodiments of the window covering may be configured as different types of window coverings.

For some embodiments of the window covering, the front side of the window covering may be considered to be the side that faces towards a window when the window covering is mounted adjacent to the window. In other embodiments, the front side of the window covering may be the side of the window covering that faces toward the interior of a room when positioned adjacent to a window or window opening.

Some embodiments of the window covering may include a bottom rail that is attached to a bottom edge of the second sheet. The bottom rail may be positioned below the first and second sets of clips. Preferably, the bottom rail is a bar, a rod, or a generally polygonal shaped elongated members and the bottom rail engages a bottommost clip of the first set of clips and a bottommost clip of the second set of clips when the window covering is raised.

The first, second and third sheets of material may be composed of numerous different types of material. For instance, any of these sheets of material may be comprised of interconnected segments of fabric, a sheet of fabric, a sheet of non-woven fabric, woven wood a film, a sheet of mesh material, a sheet of plastic or woven grass.

The mounting device may be a headrail or may be a plurality of mounting brackets for holding the roller. The mounting device may also be a headrail that is attached to one or more mounting brackets.

The first and third sheets of material may be attached to the mounting device. For instance, the top edge of the first sheet of material can be attached to the mounting device and the top edge of the third sheet of material can be attached to the mounting device. A Velcro® fastening mechanism, an adhesive, fasteners, or other fastening mechanism may be used for attaching the first and third sheets of material to the mounting device.

The plurality of first members may be attached to the first sheet of material and be positioned for forming transverse folds in the first sheet of material when the first sheet of material, second sheet of material, and third sheet of material are moved to a retracted position. Members may also be attached to the third sheet of material and be positioned for forming transverse folds in the first sheet of material when the first sheet of material, second sheet of material, and third sheet of material are moved to a retracted position.

The second sheet of material may be connected to the first and third sheets of material so that the first, second and third sheets are moveable to a retracted position via winding of the second sheet of material about the roller and extension of the second sheet of material via unwinding of the second sheet from the roller moves the first, second and third sheets of material to an extended position.

Embodiments of the window covering may utilize a lift system to actuate movement of the roller or otherwise control movement of the roller. For instance, the lift system may include a loop cord drive mechanism attached to the roller to actuate movement of the roller. The lift system could alternatively include at least one spring motor connected to the roller. For instance, the roller could include a roller shade spring motor arrangement or other spring motor arrangement used for controlling movement of the roller.

Each clip of the first set of clips and each clip of the second set of clips may have the same configuration. For instance, each clip may include a body that has a first clamping portion and a second clamping portion on a side of the body opposite the first clamping portion. The first clamping portion may be sized and configured to receive and releasably hold a portion of the first sheet of material and the second clamping portion may be sized and configured to receive and releasably hold a portion of the third sheet of material. If elongated members are positioned in the first sheet, third sheet, or both the first and third sheets, the clamping portions may also be configured to receive a portion of those members.

The first set of clips and the second set of clips may define a middle channel between the first and third sheets of material that is sized so that the second sheet of material extends through the channel. A bottommost portion of the second sheet of material may be positioned adjacent to a bottommost portion of the first sheet and a bottommost portion of the third sheet. A rail may be connected to the bottommost portion of the second sheet of material.

A window covering that includes a mounting device, a roller attached to the mounting device such that the roller is rotatable in a first direction and a second direction opposite the first direction, a first sheet of material, a second sheet of material and a third sheet of material is also provided. The first sheet of material is connected to the mounting device. The first sheet has a rear face and a front face opposite the rear face. The second sheet of material is connected to the roller such that the second sheet of material is windable about the roller when the roller is rotated in a first direction and is unwindable from the roller when the roller rotates in the second direction. The third sheet of material is connected to the mounting device such that the second sheet of material is positioned between the first and third sheets of material. The third sheet of material has a top portion, a bottom portion, a front facing toward the rear face of the first sheet of material and a rear opposite the front. The third sheet of material has a first side portion extending from the top portion to the bottom portion and a second side portion that is opposite the first side portion. The second side portion of the third sheet extends from the top portion to the bottom portion. The first side of the third sheet of material is attached to the first sheet of material adjacent to the rear face of the first sheet of material at a plurality of first locations adjacent to a first edge of the first sheet of material. The second side of the third sheet of material is attached to the first sheet of material adjacent to the rear face of the first sheet of material at a plurality of second locations located adjacent to a second edge of the first sheet of material. The second edge is opposite the first edge of the first sheet of material. The second sheet of material extends from the roller between the first positions and the second positions and between the rear face of the first sheet of material and the third sheet of material.

The locations of the first locations may be spaced apart from each other and the locations of the second locations may be spaced apart from each other. Preferably, the first locations are parallel to the second locations. Respective ones of the first and second locations may define gaps therebetween that the second sheet of material may pass through when the window covering is raised or lowered.

In some alternative embodiments of the window covering, it is contemplated that the second sheet may be replaced with a plurality of strips. The strips may be relatively wide strips of material. For instance, each strip may have a width of 5 centimeters, 6 centimeters, 7.5 centimeters, or more than 7.5 centimeters.

It should be understood that the connections between the first and third sheets of material at the first and second locations may be formed via clips or via direction connections. The direction connections may be formed via adhesives, sewing, or other fastening mechanisms that provide direct connections between the first and third sheets of material.

Other details, objects, and advantages of the invention will become apparent as the following description of certain present preferred embodiments thereof and certain present preferred methods of practicing the same proceeds.

### BRIEF DESCRIPTION OF THE FIGURES

Present preferred embodiments of my window covering are shown in the accompanying drawings and certain present preferred methods of practicing the same are also illustrated therein.

FIG. 1 is a front view of a first present preferred embodiment of my window covering in an extended, or lowered position.

FIG. 2 is a perspective view showing the first present preferred embodiment of my window covering in a partially retracted or a partially raised position.

FIG. 3 is a rear view of the first present preferred embodiment of my window covering in a partially retracted, or a partially raised position.

FIG. 4 is a perspective view showing the back of the first present preferred embodiment of my window covering in an extended or lowered position.

FIG. 5 is a fragmentary side view of the first present preferred embodiment of my window covering.

FIG. 6 is a fragmentary rear perspective view of the first present preferred embodiment of my window covering with the rear sheet of the window covering cut away to illustrate a roller, middle sheet and actuation mechanism of the first present preferred embodiment of my window covering.

FIG. 7 is a fragmentary perspective view of a second present preferred embodiment of my window covering.

FIG. 8 is a fragmentary rear perspective view of a third present preferred embodiment of my window covering.

FIG. 9 is an enlarged fragmentary view of a fourth present preferred window covering illustrating a present preferred clip that may be utilized in embodiments of my window covering.

FIG. 10 is an exploded view of a first present preferred actuation mechanism that may be used to actuate movement of rollers in embodiments of the window covering.

FIG. 11 is an exploded view of a second present preferred actuation mechanism that may be used to actuate movement of rollers in embodiments of the window covering.

FIG. 12 is an enlarged fragmentary view of a present preferred window covering that may utilize the second present preferred embodiment of the actuation mechanism shown in FIG. 11.

FIG. 13 a fragmentary side view of a fifth present preferred embodiment of my window covering.

FIG. 14 is a perspective view showing the back of the fifth present preferred embodiment of my window covering in an extended or lowered position.

### DESCRIPTION OF PRESENT PREFERRED EMBODIMENTS

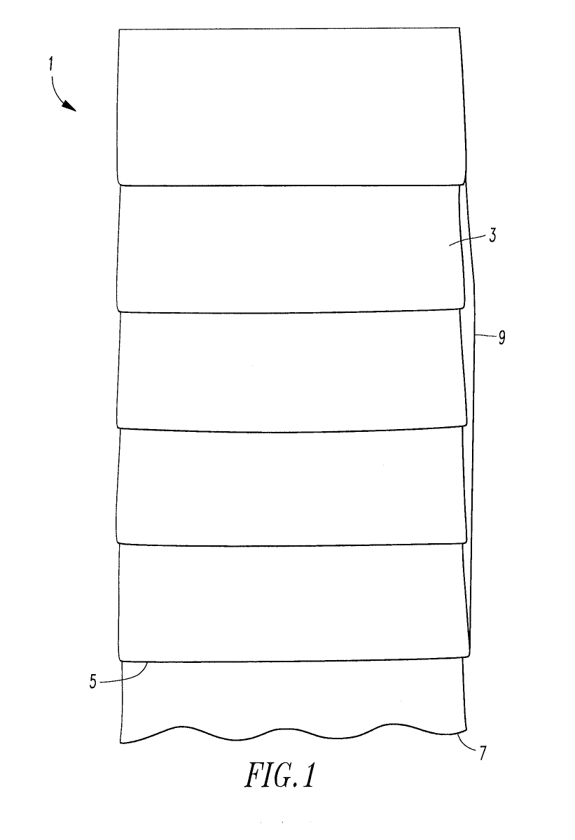

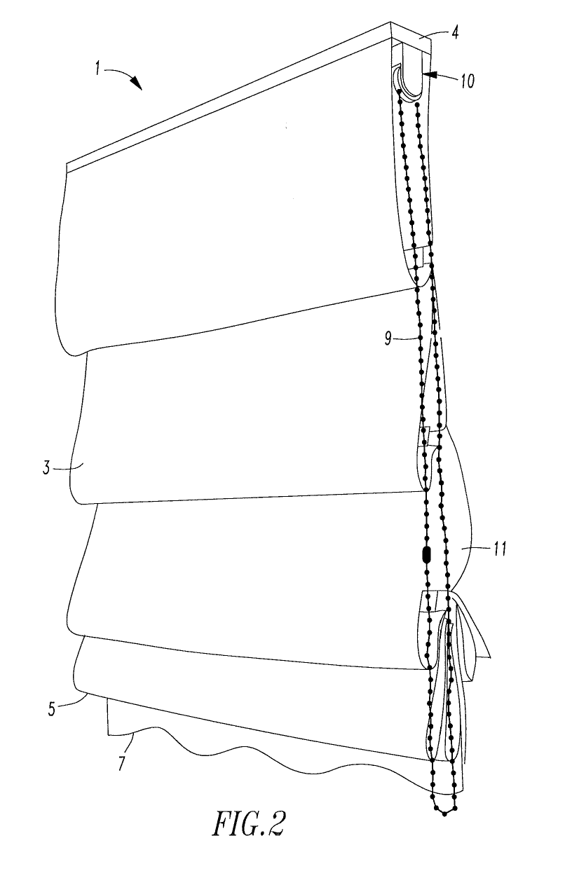

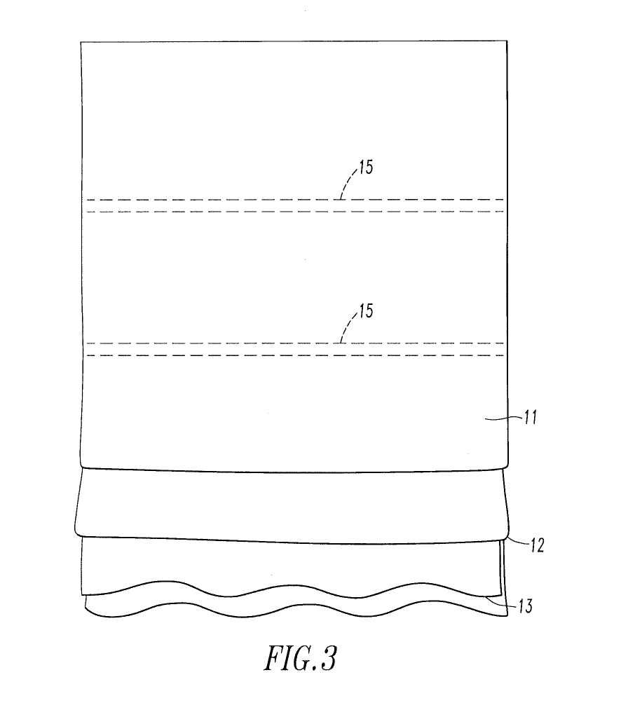

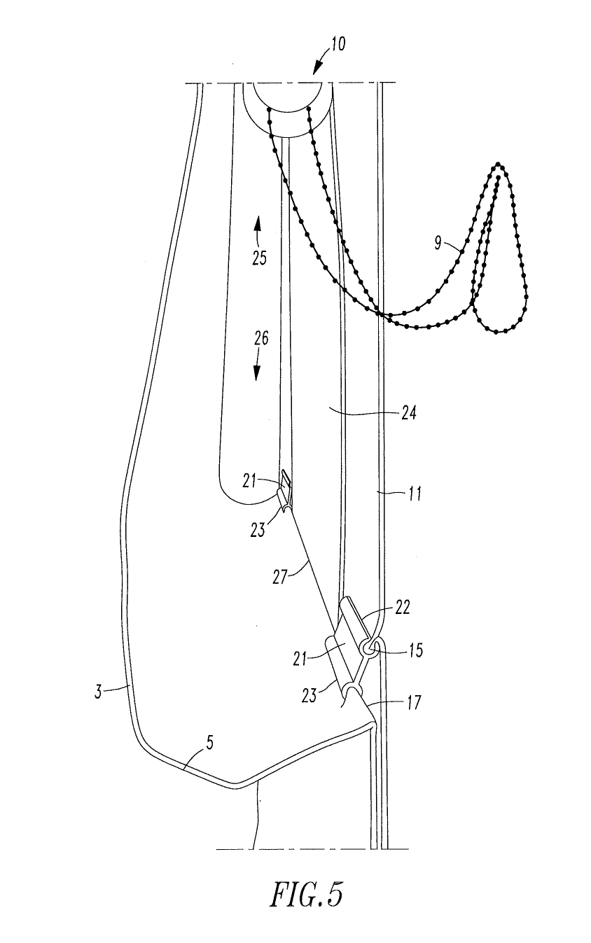

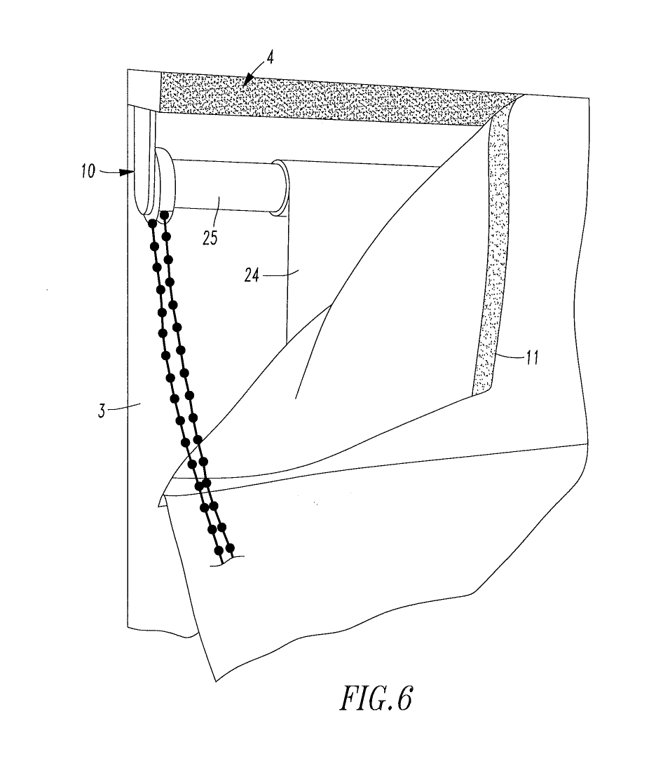

Referring to FIGS. 1-6 a window covering may be configured as a Roman shade 1. The window covering may include a front sheet of material 3 that is attached to a headrail 4 adjacent to the top portion of the front sheet of material 3. The attachment may be releasable, such as an attachment using a Velcro® attachment mechanism, buttons or snaps, or may be a non-releasable attachment or permanent attachment via adhesives, fasteners, fastening devices, or other attachment mechanisms. The bottom portion 7 of the front sheet of material may be configured to hang loose and may have a scalloped shape or other configuration or shape to provide a desired aesthetic effect to the front of the window covering.

It should be understood that the headrail 4 may be part of a mounting device. Mounting brackets, or at least one mounting bracket, may be attached to the headrail for mounting the window covering adjacent to a window. Fasteners, such as screws, may also be used for attaching the mounting brackets to the headrail, to a portion of the frame of a window opening, or to both the headrail and the frame of the window opening.

In alternative embodiments, the mounting device may not utilize a headrail, but may simply utilize a plurality of brackets for receiving and holding the roller 4. The top portion of the front sheet 3 may also be attached to such brackets.

A rear sheet of material 11 may also be attached at its top portion to the headrail 4. The rear sheet of material 11 may be releasably attached or more securely or fixedly attached to the headrail similarly to the front sheet of material 3 discussed above. For instance, snaps, buttons, Velcro® attachment mechanisms, adhesives, fasteners or other attachment mechanisms may be used to attach the rear sheet of material 11 to the headrail 4. The bottom portion 13 of the rear sheet 11 may be scalloped or provided with any other desirable configuration or shape to provide a desired aesthetic effect.

Clips 21 may be attached to the front sheet of material and the rear sheet of material in two parallel rows or columns adjacent to opposite edges of the front and rear sheets of material. For instance, the first set of clips may be positioned in a column adjacent to the right side of the front and rear sheets of material. The second set of clips may be positioned in a column adjacent to the left side of the front and rear sheets of material. The clips may be positioned to help the front sheet of material 3 form transverse folds 5. Elongated members 17 may be positioned in the front sheet of material 3 to help form the folds. The folds 5 may be formed when the window covering is raised or may be configured to be present even when the shade is in its lowered position. Folds may also be formed on the rear sheet of material 11 when the window covering is raised as a result of the placement of the clips 21 and elongated members 15 such as rods or bars that are positioned in the rear sheet of material 11.

Each clip 21 has a body and a first clamping portion 23 and a second clamping portion 22 opposite the first clamping portion 23. The first and second clamping portions are on opposite sides of the body of the clip 21. Preferably, the clip 21 is composed of a polymeric material such as polyvinyl chloride, polycarbonate or other plastic.

The clamping portions of each clip 21 are sized to receive and hold portions of the front and rear sheets of material. For instance, the first clamping portion 23 is sized to receive a portion of the front sheet of material 3 that encloses an elongated member 17 in the front sheet of material. The first clamping portion 23 engages the front sheet of material 23 and also receives and holds a portion of the elongated member 17 in the first sheet of material. The second clamping portion 22 is sized to receive and hold a portion of the rear sheet of material 11. The second clamping portion 22 receives and holds a portion of the elongated member 15 in the rear sheet of material 11 and directly engages a portion of the rear sheet of material that encloses the elongated member 15. Each clip 21 is positioned adjacent to an edge of the rear and front sheets of material and connects the rear sheet of material to the front sheet of material via the first and second clamping portions.

The clamping portions may also permit the clip to pivot about a portion of the elongated members 15 or 17 that they hold when the front and rear sheets of material are raised or lowered. The clips may be configured to pivot about 180°. Such pivoting may help form or define the folds 5 formed in the front sheet of material or rear sheet of material 11 when the shade is raised and may also help define the size or shape of the folds 5 when the front sheet is positioned at a lowered position or an extended position.

A middle sheet of material 24 is attached to a roller 25 such that the middle sheet 24 may be wound about the roller when the roller rotates in a first direction and may be unwound or extended from the roller 25 when the roller rotates in a second direction that is opposite the first direction. In some embodiments the first direction may be a clockwise direction and the second direction may be a counterclockwise direction. Of course, in other embodiments the first direction may be a counterclockwise direction and the second direction may be a clockwise direction. The middle sheet of material 24 is positioned between the front sheet of material 3 and the rear sheet of material 11 and between the two sets of clips.

A loop cord drive 10 that includes a loop cord 9 is attached to the roller 25. An operator may move the loop cord 9 to actuate the loop cord drive 10 to rotate the roller 25 for retracting or extending the middle sheet to raise or lower the window covering. Alternative embodiments may utilize other actuation mechanisms or lift systems, such as a spring motor arrangement. For instance, spring motors often used in rollers of roller shades or other spring motor arrangements may be utilized as a lift system or actuation mechanism in embodiments of the window covering.

The middle sheet 24 may extend through a channel 26 defined by the spacing between the front 3 and rear 11 sheets of material and the gaps 27 formed between the opposite set or columns of clips 21 positioned on opposite edges of the front and rear sheets of material. The channel 26 and the portion of the middle sheet 24 that extends through the channel 26 are positioned adjacent to a middle portion of the front and rear sheets of material.

A bottom portion of the middle sheet 24 is attached to a bottom rail 19. The bottom rail may be a rod, bar or polygonal shaped elongated member. The bottom rail 19 may be attached to the middle sheet 24 via an adhesive or interference fit between a portion of the middle sheet 24 and the bottom rail 19 or both such attachment mechanisms. Alternatively, tape, clips, or other attachment mechanisms may be positioned between the middle sheet 24 and the bottom rail 19 to attach the middle sheet 24 to the bottom rail 19.

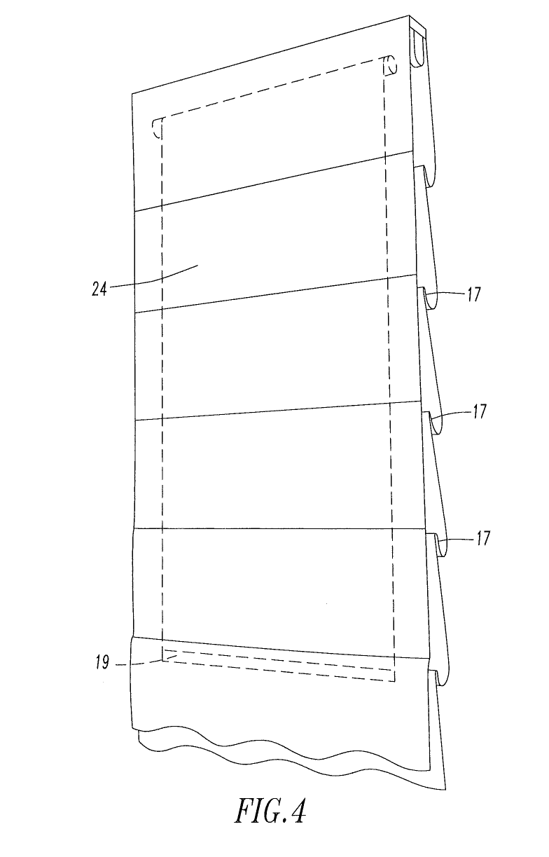

As may be appreciated from FIG. 4, the bottom rail 19 may be positioned so that it is between the bottom portions of the rear sheet and front sheet of material. Alternatively, the bottom rail may be positioned below the bottom portions of the front sheet, rear sheet, or both front and rear sheets. In some embodiments, fabric or other material may be attached to the bottom rail to form a skirt for the window covering. The skirt may be sized and configured to provide a desired aesthetic effect.

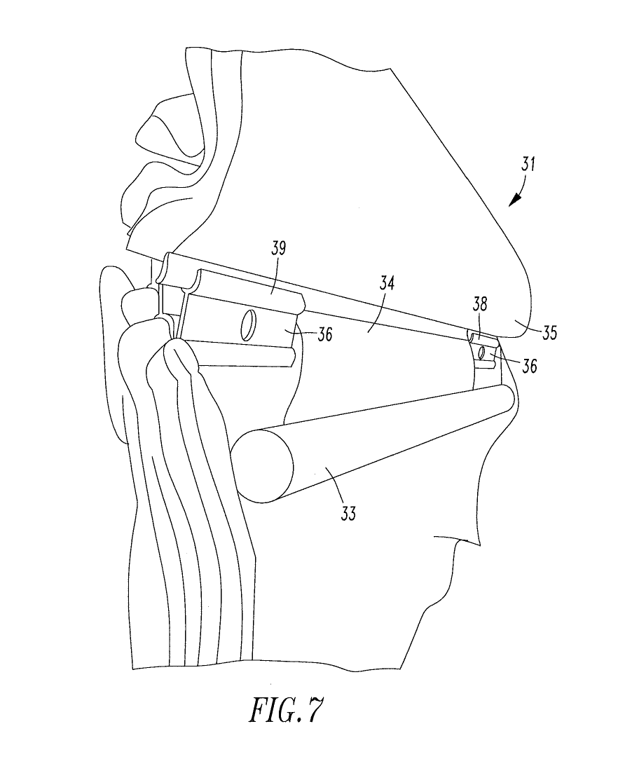

As may be seen in the embodiment of the window covering 31 shown in FIG. 7, the bottom rail may be positioned to extend below a bottom portion 35 of a rear sheet of material below a gap formed between the bottommost clips 38 and 39 of the sets of clips. The clips 38 and 39 may be similar to clips 21 discussed above. The middle sheet 34 may extend through the gap between the bottommost clips. When the window covering 31 is raised, the bottom rail 33 may engage the bottommost clips 38 and 39. The clips may include a groove or opening 36 to receive a portion of the bottom rail 33 or to help locate the bottom rail 33 when the window covering is raised or lowered.

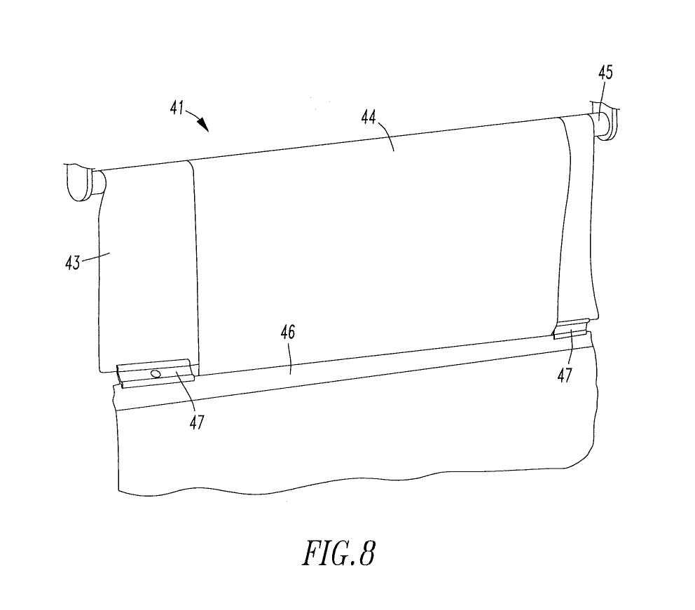

Referring to FIG. 8, embodiments of the window covering 41 may alternatively include a front sheet of material 43 that is attached to the mounting device adjacent to the roller 45 and middle sheet 44 positioned on the roller 45 for actuating lifting and lowering of the window covering 41. The roller 45 may include a spring motor configuration similar to those of roller shades for controlling the lowering of the shade and raising of the shade and for maintaining positions of the shade. The rear sheet 46 may be attached to the front sheet of material 43 via clips 47. The clips 47 may be similar to clips 21 or clips 38 and 39 discussed above. It should be understood that the rear sheet 46 does not have to have its top portion attached directly to the mounting device or headrail for such embodiments. Instead, the top portion of the rear sheet may be attached to the front sheet via the clips 47 without also being attached to the headrail or other portion of the mounting device of the window covering.

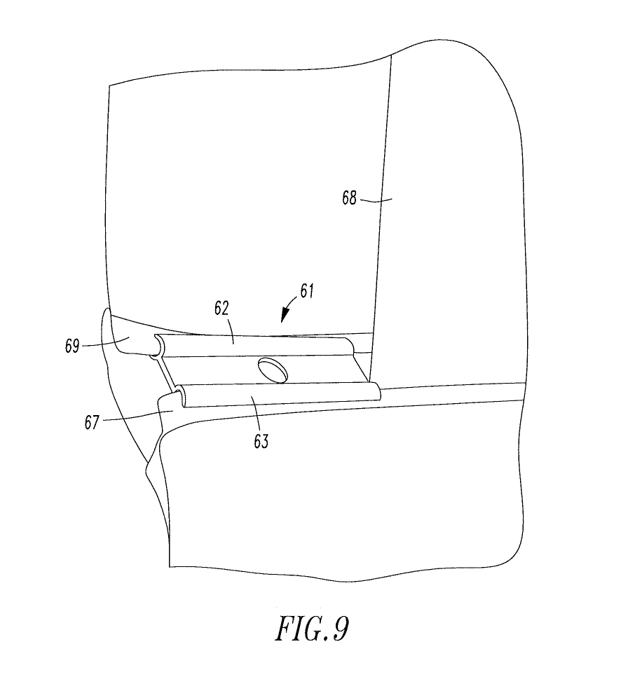

As may be seen in FIG. 9, a present preferred clip 61 that may be used in embodiments of the window covering is shown in an enlarged view to better illustrate the function and configuration of the clip 61. The clip 61 may function similarly to clips 21 and 38 and 39 discussed above. Clips 61 include clamping portions 62 and 63 on opposite sides of the clip 61. The clamping portion 62 is sized to receive and hold a portion of the front sheet of material and a portion of an elongated member positioned therein 69. The clamping portion 63 is sized to receive and hold a portion of the rear sheet of material and a portion of an elongated member positioned therein 67. The elongated members 69 and 67 may be positioned in pockets sewn into the front and rear sheets of material. The elongated members may be bars or rods composed of metal or other material. The middle sheet of material 68 may be positioned adjacent to the clips 61 between the front and rear sheets of material and the clips 61 positioned adjacent to opposite edges of the front and rear sheets of material.

It should be understood that the clamping portions of the clips may have different shapes or configurations for attaching to the front or rear sheets of material. For instance, instead of generally C-shaped elongated clamping portions shown in FIG. 9, the clamping portions may be configured to have a generally Z-shaped configuration or a generally G-shaped configuration for clamping portions of the rear and front sheets of material or may be shaped to clamp portions of the rear and front sheets of material that only include fabric or sheet material and do not include any elongated member positioned in the sheets. The clamping portions of the clips are preferably shaped to permit the clips to pivot or rotate while holding portions of the front and rear sheets of material so that the clips are moveable when the front and rear sheets extend or retract during raising and lowering of the window covering.

The clips 61 may provide a releasable attachment to the rear and front sheets of material. This feature enables a fabricator to reposition the clips 61 to adjust the location of the clips and to replace the front sheet or the back sheet. Further, the clips 61 may be configured to release the front or rear sheet of material when a force acts on the clips to help prevent small children from being entangled between the front and rear sheets of material or the transverse folds that may be formed therein.

In other embodiments, an adhesive may be used in combination with the clamping portions of the clips. Of course, other attachment mechanisms may also be utilized in combination with the clips 61 to provide a secure non-releasable attachment.

It should be appreciated that embodiments of the window covering that have both a rear sheet and a front sheet that form transverse folds may provide a Roman shade-like aesthetic effect to both an interior portion of a room and a window side of the room. This is an improvement over conventional Roman shades that only provide a desirable aesthetic effect to one side of a room, typically the interior side of the room.

Embodiments of my window covering may permit the window covering to look like a Roman shade and provide an aesthetic effect that is exactly like, or at least comparable, to a Roman shade without using any lifting tapes or lift cord portions for raising and lowering the window covering. The non-use of lifting tape or lift cords improve the safety of the window covering by eliminating a potential entanglement threat to small children or infants. Further, the use of the rear sheet of material may permit a window facing portion of the window covering to provide a Roman shade like aesthetic effect or a roller shade like effect, which is an improvement over the visible and exposed lift cords or lifting tapes common on most conventional Roman shades.

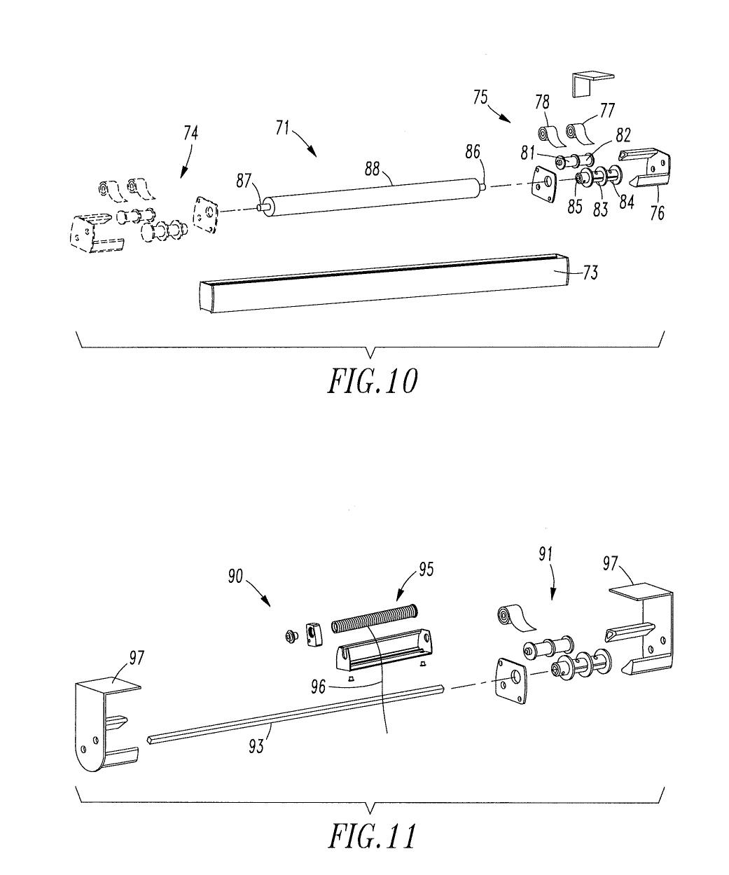

Embodiments of my window covering may utilize any of a number of different actuation mechanisms or lift systems. For instance, lift system 71 may be utilized in embodiments of the window covering to control movement of the roller of the window covering for maintaining position of the window covering or to raise or lower the window covering material. The lift system 71 includes a first spring motor unit 75 that includes a spring motor housing 76 and rollers that define multiple pulleys for springs of the spring motors. A roller 88 for receiving the middle sheet is attached to the spring motor unit. A first stubbed end 86 of the roller 88 may be received in an opening in the housing 76 and in an opening 85 in the shaft of one pulley. The other stubbed end 87 of the roller 88 may be held for rotation in an opening of a wall or cradle or may be received by a second spring motor unit 74, which is shown in dotted line in FIG. 10.

The housing 76 is attached to a first spool 81, a second spool 82, a third spool 83 and a fourth spool 84. The spools are all rotatable in a first direction and in the second direction. The first and second spools 81 and 82 may be portions of a double pulley and the third and fourth 83, 84 spools may be portions of a double pulley. The third spool 83 may also include an opening 85 that is sized and configured to receive the first end 86 of the roller 88 to attach the roller 88 to the third spool 83. It is contemplated that a bushing (not shown) may also be attached between the roller 88 and the housing 76 or shaft along which the third pulley 83 rotates to provide a tight interference attachment between the roller 88 and third spool 83. It should be appreciated that alternative embodiments of my window covering may include a spring motor that has the rotatable shaft attached to the first spool 81 instead of the third spool 83.

A first spring member 78 is attached between the first spool 81 and the third spool 83. Opposite ends of the spring member 78 may be attached to the first spool 81 and third spool 83, respectively. The first spring member 78 is preferably composed of type 301 stainless steel, or grade 301 stainless steel, and is preferably obtained from Vulcan Spring and Manufacturing Co., which has a place of business located at 501 Schoolhouse Road, Telford, Pa. 18969 USA. The type 301 stainless steel has a negative gradient so that the strength of the steel is different at different locations along the length of the first spring member 78. Such a variation in strength may be provided by heat treating the steel so that the microstructure of the spring member is different at different locations along the length of the spring member 78 so the strength of different portions of the spring member 78 along the length of the spring member are different. It should be understood the appearance of such a microstructure may be different for different types of steels that may be used in spring members.

A portion of the first spring member 78 is moveable from the first spool 81 to the third spool 83 such that the portion of the first spring member 78 is windable about the third spool 83 when the third spool rotates in the second direction. The first spring member 78 is windable about the first spool 81 when the third spool 83 rotates in the first direction.

The first spring member is configured so that the first spring member has a different toughness at different portions of the spring member located along the length of the first spring member such that the first spring member exerts an amount of force as the portion of the first spring member winds about the second spool that progressively increases such that the second spool can prevent movement of the rotatable shaft to maintain a position of the window covering material after the window covering material is moved to the retracted position. The first spring member is also configured to exert a progressively lesser amount of force as the portion of the first spring member winds about the first spool such that the second spool can prevent movement of the rotatable shaft to maintain a position of the window covering material after the window covering material is moved to the extended position.

The second spring member 77 is preferably the same material as the first spring member 78 and has the same shape and configuration as the first spring member 78. Opposite ends of the second spring member 77 are attached to the second spool 82 and the fourth spool 84, respectively. A portion of the second spring member 77 is moveable from the second spool 82 to the fourth spool 84 such that the portion of the second spring member 77 is windable about the fourth spool 84 when the second spool 82 rotates in the second direction. The second spring member 77 is windable about the second spool 82 when the fourth spool 84 rotates in the first direction.

The second spring member 77 has an elongated body that has a generally rectangular shape. The body of the second spring member 77 also has a uniform thickness and width. The second spring member 77 is configured so that the second spring member 77 has a different toughness at different portions of the spring member 77 located along the length of the second spring member such that the second spring member exerts an amount of force as the portion of the second spring member winds about the fourth spool 84 that progressively increases such that the fourth spool 84 can help prevent movement of the roller 88 to maintain a position of the middle sheet of material that may be attached to the roller 88 after the window covering is moved to a desired position, such as a retracted position or an extended position. The second spring member 77 is also configured to exert a progressively lesser amount of force as the portion of the second spring member winds about the second spool such that the fourth spool can prevent movement of the rotatable shaft to maintain a position of the window covering material after the window covering material is moved to the extended position.

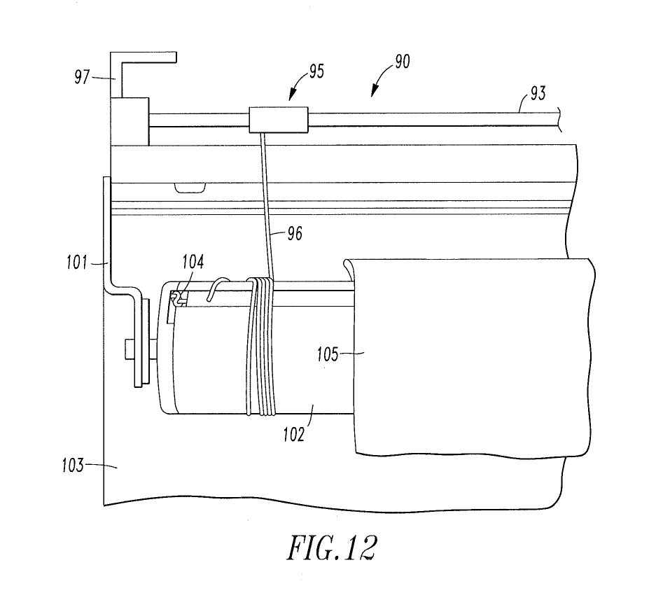

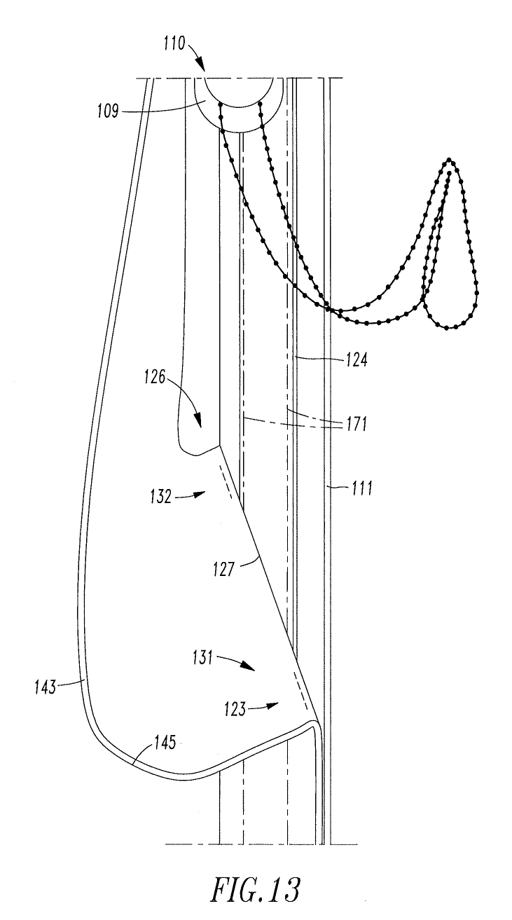

Another lift system 90 that may be utilized in embodiments of my window covering may be appreciated from FIGS. 11 and 12. The lift system 90 may include a spring motor unit 91 that includes a spring that extends between two spools for controlling the movement of shaft 93 attached to the spring motor unit 91. A spool 95 may be provided in a cradle unit that is attached to the shaft 93 so that rotation of the shaft 93 in one direction causes a cord 96 attached to the spool 95 to rotate to unwind the cord 96 from the spool. Rotation of the shaft 93 in an opposite direction causes the spool 95 to rotate so that the cord 96 is wound about the spool 95.

The cord 96 may extend from the cradle unit to a roller or roller assembly 102. An end of the cord 96 may be attached to a part or portion of the roller 102 or roller assembly. The opposite end of the cord 96 may be attached to the spool of the cradle unit. It should be appreciated that the shaft 93 and cord 96 on the cradle unit connect the spring motor unit 91 to the roller 102.

The roller assembly may be attached to brackets 97 that may be positioned on opposite sides of the lift system 90. For instance, brackets 101 may be attached to the brackets 97 of the lift system for holding the roller 102. The brackets 97 may be the mounting device for the window covering and be configured to mount the window covering to the frame of a window opening or adjacent to a window.

A front sheet of material 103 may be attached to a front side of the brackets 97. A rear sheet (not shown in FIGS. 11 and 12) may be attached to the front sheet adjacent to the rear side of the window covering or may be attached to the rear side of the brackets 97. As discussed with reference to above mentioned embodiments, clips may also be utilized to attach the rear sheet to the front sheet. A middle sheet 105 may be wound about the roller 102 and extending from the roller 102 to lift or lower the window covering.

The cord 96 may be attached to the spool 95 and roller 102 such that movement of the shaft 93 in a first direction causes the cord to wind about the spool 95 and unwind from the roller 102 so that the roller 102 rotates in a first direction to wrap the middle sheet 105 around the roller 102 to raise the window covering. Movement of the shaft 93 in an opposite direction may cause the cord 96 to unwind from the cradle unit and wind about the roller 102 to extend the middle sheet 105 from the roller 102 and lower the window covering.

Of course, alternative embodiments of the lift system may be configured such that unwinding of the cord 96 from the spool 95 of the cradle unit is configured to cause the roller to rotate to wind the middle sheet 105 about the roller to raise the window covering. For such embodiments, movement of the shaft 93 to cause the cord 96 to wind about the spool 95 of the cradle unit may then cause the middle sheet 105 to extend from the roller to lower the window covering.

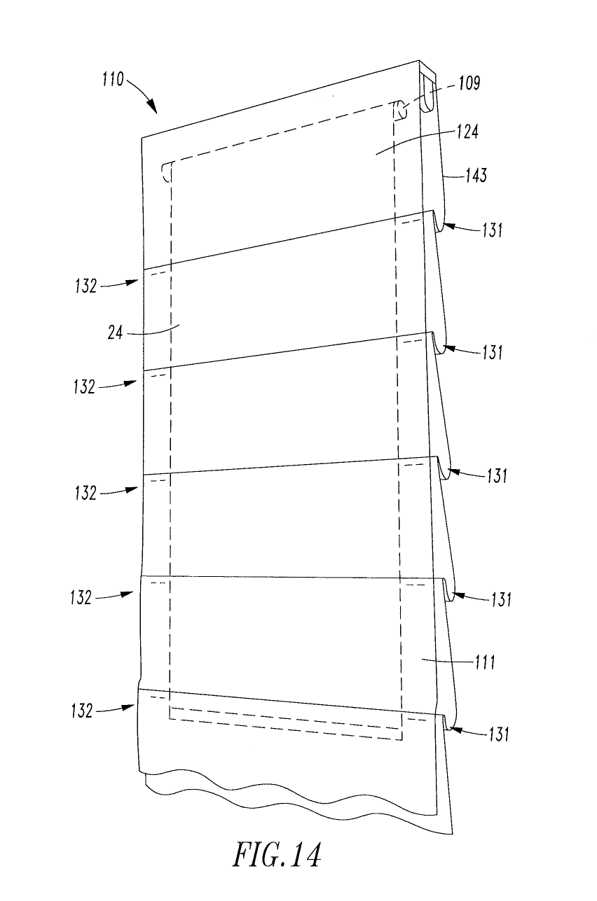

Another alternative embodiment of my window covering is shown in FIGS. 13-14. The Roman shade 110 may include a front sheet 143 that may be raised to form folds 145, a rear sheet of material 111 and a middle sheet of material 124 that extends from a roller 109 between the first and second sheets of material 143 and 111. A first side or edge of the first sheet of material may be connected to a first side 123 or first edge of the third sheet of material via a direct connection formed by sewing, bonding, gluing, sonic welding, adhering, or otherwise directly connecting those portions together. Such connections may occur at spaced apart first positions 131 located along the length of the first side of the first and third sheets of material. A second side 125 or edge of the first sheet of material may also be connected to a second side or second edge of the third sheet of material via a direct connection formed by sewing, bonding, gluing, sonic welding, adhering, or otherwise directly connecting those portions together. Such connections may occur at spaced apart second positions 132 located along the length of the second side of the first and third sheets of material. The connections between the first and third sheets of material at the first positions and second positions 131 and 132 may extend inwardly from adjacent to the edges of the first and third sheets of material.

In some alternative embodiments, the second sheet of material may be a plurality of relatively wide strips 171. The strips 171 may be spaced from each other and may be wound and unwound from the roller. Each strip may be two inches wide, five centimeters wide, three inches wide, seven centimeters wide, over seven centimeters wide, or over three inches wide.

The spacing between the first and second positions 131 and 132 may define gaps 127 through which the second sheet of material may pass when the shade 110 is raised or lowered. The gaps 127 may be part of a channel 126 defined by the connections between the first and third sheets of material at the first positions 131 and second positions 132 and the first and third sheets of material 143 and 111.

It should be appreciated that other variations of the present preferred embodiments discussed above may be made. For example, the use of variations to lifting mechanisms or lift systems utilized in the window covering may include embodiments of lifting mechanisms as disclosed in my U.S. patent application Ser. Nos. 12/755,477, 12/770,881, and 12/780,245. The entirety of my U.S. patent application Ser. Nos. 12/755,477, 12/770,881, and 12/780,245 are hereby incorporated by reference herein. It is also contemplated that various spring motor arrangements may be utilized for actuation of the lifting and lowering of the window covering material in different embodiments of my window covering. As another example of an alternative design option, the material choices for the material of the rear, front or middle sheets may be any suitable material desired by a consumer, retailer or designer. For instance, any of the front, rear, and middle sheets may be composed of interconnected segments of fabric, a sheet of fabric, a sheet of non-woven fabric, a film, a sheet of mesh material, a sheet of plastic, woven grass or woven wood.

While certain present preferred embodiments of my window covering and certain embodiments of methods of practicing the same have been shown and described, it is to be distinctly understood that the invention is not limited thereto but may be otherwise variously embodied and practiced within the scope of the following claims,

I claim:

1. A window covering, the window covering having a front side and a rear side, the window covering comprising:
a mounting device;
a roller attached to the mounting device such that the roller is rotatable in a first direction and a second direction opposite the first direction;
a first sheet of material connected to the mounting device adjacent to the front side of the window covering;
a second sheet of material connected to the roller such that the second sheet of material is windable about the roller when the roller is rotated in a first direction and is unwindable from the roller when the roller rotates in the second direction;
a third sheet of material connected to at least one of the mounting device and the first sheet of material adjacent to the rear side of the window covering such that the second sheet of material is positioned between the first and third sheets of material;
a plurality of clips comprising a first set of clips and a second set of clips, the first set of clips positioned adjacent to a first edge of the first sheet material and a first edge of the third sheet of material, the second set of clips positioned adjacent to a second edge of the first sheet of material and the second edge of the third sheet of material, the first edges of the first and third sheets of material being opposite the second edges of the first and third sheets of material;
each clip of the first set of clips being attached to the first sheet of material adjacent to a respective first edge portion of the first sheet of material and also attached to the third sheet of material adjacent to a respective first edge portion of the third sheet of material, each clip of the second set of clip attached to the first sheet of material adjacent to a respective second edge portion of the first sheet of material and also attached to the third sheet of material adjacent to a respective second edge portion of the third sheet of material;
wherein the second sheet of material extends from the roller between the first and second sets of clips and between the first sheet of material and the third sheet of material.

2. The window covering of claim 1 also comprising a bottom rail attached to a bottom edge of the second sheet, the bottom rail positioned below the first and second set of clips.

3. The window covering of claim 2 wherein the bottom rail is a bar, rod, or a generally polygonal shaped elongated member and wherein the bottom rail engages a bottommost clip of the first set of clips and a bottommost clip of the second set of clips when the window covering is raised.

4. The window covering of claim 1 wherein the first sheet of material is comprised of interconnected segments of fabric, a sheet of fabric, a sheet of non-woven fabric, woven wood, a film, a sheet of mesh material, or a sheet of plastic; and
wherein the second sheet of material is comprised of a interconnected segments of fabric, a sheet of fabric, a sheet of non-woven fabric, a film, a sheet of mesh material, or a sheet of plastic, and woven wood; and
wherein the third sheet of material is comprised of a interconnected segments of fabric, a sheet of fabric, a sheet of non-woven fabric, a film, a sheet of mesh material, woven wood, or a sheet of plastic.

5. The window covering of claim 1 wherein the mounting device is comprised of at least one of a headrail and at least one mounting bracket.

6. The window covering of claim 1 wherein the first sheet of material is connected to the mounting device via a top edge of the first sheet being attached to the mounting device and the third sheet of material is connected to the mounting device via a top edge of the third sheet being attached to the mounting device.

7. The window covering of claim 1 further comprising a plurality of members attached to the first sheet of material, the members being positioned for forming transverse folds in the first sheet of material when the first sheet of material, second sheet of material and third sheet of material are moved to a retracted position.

8. The window covering of claim 1 wherein the second sheet of material is connected to the first sheet of material and the third sheet of material such that the first sheet, second sheet and third sheet are moveable to a retracted position via winding of the second sheet of material about the roller and wherein the first sheet, second sheet and third sheet are moveable to an extended position via unwinding of the second sheet of material from the roller

9. The window covering of claim 1 further comprising a lift system connected to the roller to actuate rotation of the roller.

10. The window covering of claim 9 wherein the lift system is comprised of a loop cord drive mechanism attached to the roller, the loop cord drive mechanism connected to the roller to actuate rotation of the roller.

11. The window covering of claim 9 wherein the lift system is comprised of at least one spring motor connected to the roller.

12. The window covering of claim 1 wherein a plurality of first elongated members are positioned at different locations in the first sheet of material and a plurality of second elongated members are positioned at different locations in the third sheet of material and wherein each clip of the first set of clips and each clip of the second set of clips is comprised of a body that has a first clamping portion that receives a portion of a respective first elongated member of the first elongated members and also has a second clamping portion opposite the first clamping portion that receives a portion of a respective second elongated member of the second elongated members.

13. The window covering of claim 12 wherein each first elongated member is at least partially surrounded by a portion of the first sheet of material and each second elongated member at least partially surrounded by a portion of the third sheet of material.

14. The window covering of claim 1 wherein the roller is an elongated member, a rod or a generally cylindrical structure.

15. The window covering of claim 1 wherein the first set of clips and second set of clips define a middle channel between the first and third sheets of material that is sized such that the second sheet of material extends through the channel and has a bottommost portion that is positioned adjacent to a bottommost portion of the first sheet and a bottommost portion of the third sheet and wherein a rail is connected to the bottommost portion of the second sheet of material.

16. A window covering comprising:
a mounting device;
a roller attached to the mounting device such that the roller is rotatable in a first direction and a second direction opposite the first direction;
a first sheet of material connected to the mounting device, the first sheet having a rear face and a front face opposite the rear face;
a second sheet of material connected to the roller such that the second sheet of material is windable about the roller when the roller is rotated in a first direction and is unwindable from the roller when the roller rotates in the second direction;
a third sheet of material connected to the mounting device such that the second sheet of material is positioned between the first and third sheets of material, the third sheet of material having a top portion, a bottom portion, a front facing toward the rear face of the first sheet of material and a rear opposite the front, the third sheet of material having a first side portion extending from the top portion to the bottom portion and a second side portion that is opposite the first side portion, the second side portion extending from the top portion to the bottom portion;
the first side of the third sheet of material being attached to the first sheet of material adjacent to the rear face of the first sheet of material at a plurality of first locations adjacent to a first edge of the first sheet of material,
the second side of the third sheet of material being attached to the first sheet of material adjacent to the rear face of the first sheet of material at a plurality of second locations located adjacent to a second edge of the first sheet of material, the second edge being opposite the first edge of the first sheet of material;
wherein the second sheet of material extends from the roller between the first positions and the second positions and between the rear face of the first sheet of material and the third sheet of material.

17. The window covering of claim 16 further comprising a lift system connected to the roller to control rotation of the roller, wherein the third sheet is directly connected to the first sheet at the first positions and the second positions via sewn connections, and wherein the window covering is a Roman shade.

18. The window covering of claim 17 wherein the mounting device is comprised of a headrail and at least one mounting bracket attached to the headrail.

19. The window covering of claim 17 also comprising a bottom rail attached to a bottom edge of the second sheet of material.

20. The window covering of claim 19 wherein the bottom rail is a bar, rod, or a generally polygonal shaped elongated member and wherein the first sheet of material is comprised of fabric, woven wood, or interconnected fabric segments, the second sheet is comprised of fabric and the third sheet is comprised of fabric or interconnected segments of fabric.

21. The window covering of claim 16 wherein the first locations are spaced apart from one another and the second locations are spaced apart from one another and the first locations are parallel to the second locations to define gaps through which the second sheet of material passes, the gaps being portions of a channel through which the second sheet of material passes, the channel being defined by the first and third sheets of the material.

22. The window covering of claim 21 wherein the first locations extend inwardly from the first edge of the first sheet of material and first side of the third sheet of material and wherein the second locations extend inwardly from the second edge of the first sheet of material and the second side of the third sheet of material.

23. The window covering of claim 21 wherein the attachment of the first sheet of material to the third sheet of material at the first location's and second locations are direct attachments via adhesives or sewing.

24. A window covering comprising:
a mounting device;
a roller attached to the mounting device such that the roller is rotatable in a first direction and a second direction opposite the first direction;
a first sheet of material connected to the mounting device, the first sheet having a rear face and a front face opposite the rear face;
a plurality of strips of material connected to the roller such that the at least one strip of material is windable about the roller when the roller is rotated in a first direction and is unwindable from the roller when the roller rotates in the second direction, each strip of the at least one strip of material being at least 2.5 inches wide or at least 6 centimeters wide;
a second sheet of material connected to the mounting device such that the strips are positioned between the first and second sheets of material, the second sheet of material having a top portion, a bottom portion, a front facing toward the rear face of the first sheet of material and a rear opposite the front, the second sheet of material having a first side portion extending from the top portion to the bottom portion and a second side portion that is opposite the first side portion, the second side portion extending from the top portion to the bottom portion;
the first side of the second sheet of material being attached to the first sheet of material adjacent to the rear face of the first sheet of material at a plurality of first locations adjacent to a first edge of the first sheet of material,
the second side of the second sheet of material being attached to the first sheet of material adjacent to the rear face of the first sheet of material at a plurality of second locations located adjacent to a second edge of the first sheet of material, the second edge being opposite the first edge of the first sheet of material;
wherein the strips extend from the roller between the first positions and the second positions and between the rear face of the first sheet of material and the second sheet of material.
